(19) United States
(12) Patent Application Publication
(10) Pub. No.: US 2004/0024120 A1
(43) Pub. Date: Feb. 5, 2004

(54) Resin composition comprising saponifield ethylene-vinyl acetate copolymer and formed product obtained using the same

(76) Inventors: Kyoko Hino, Ibaraki-shi (JP); Satoshi Hanada, Ibaraki-shi (JP); Hiroaki Takahata, Toyonaka-shi (JP); Ryuma Kuroda, Ibaraki-shi (JP)

Correspondence Address: SUGHRUE MION, PLLC, 2100 PENNSYLVANIA AVENUE, N.W., WASHINGTON, DC, 20037, US

(21) Appl. No.: 10/343,603

(22) PCT Filed: Feb. 7, 2002
(86) PCT No.: PCT/JP02/01028

(51) Int. Cl. C08F 8/00

(52) U.S. Cl. 525/55

(57) ABSTRACT

A resin composition containing from 85 parts by weight inclusive to 100 parts by weight exclusive of a polymer (1) and from 0 parts by weight exclusive to 15 parts by weight inclusive of a polymer (2), provided that the total of the polymer (1) and the polymer (2) is assigned to be 100 parts by weight,

the polymer (1) being a saponified ethylene-vinyl acetate copolymer having an ethylene unit content of from 20 to 60% by mole and a saponification degree of from 90 to 100%, and

the polymer (2) being a saponified ethylene-vinyl acetate copolymer having an ethylene unit content of from 85 to 95% by mole and a saponification degree of from 45 to 70%.

The resin composition exhibits superior gas-barrier properties under high humidity conditions as well as under dry conditions, and provides a formed product of high quality.

### TECHNICAL FIELD

The present invention relates to a resin composition comprising a saponified ethylene-vinyl acetate copolymer, which exhibits superior gas-barrier properties under high humidity conditions as well as under dry conditions, and a formed product obtained using the same.

### BACKGROUND ART

A saponified ethylene-vinyl acetate copolymer (hereinafter sometimes referred to as EVOH) is a thermoplastic resin superior in gas-barrier properties, and extensively used in the fields of foods, medicines and electronic materials, wherein gas-barrier properties, particularly an oxygen-barrier property is required.

However, EVOH has a characteristic feature that its gas-barrier properties are superior under dry conditions, whereas the gas-barrier properties are markedly deteriorated under high humidity conditions such as the relative humidity of 80% RH or higher. Therefore, when goods easily degraded due to oxygen are hermetically wrapped with a wrapping material obtained using EVOH, and in the case where the humidity outside the package becomes high, or the moisture activity of the wrapped goods is high, the goods wrapped may be degraded due to oxygen passing into the package through the wrapping material.

In view of the above-described conventional technology, an object of the present invention is to provide an EVOH resin composition exhibiting superior gas-barrier properties under high humidity conditions such as the relative humidity of 80% RH or higher as well as under dry conditions.

### DISCLOSURE OF INVENTION

The present inventors have found a fact that the above-described object can be achieved by providing a resin composition by blending specific saponified ethylene-vinyl acetate copolymers in a specific proportion, which saponified copolymers are different in ethylene unit content and in saponification degree of vinyl acetate units. Thereby, the present invention has been accomplished.

Thus, the present invention relates to a resin composition comprising from 85 parts by weight inclusive to 100 parts by weight exclusive of a polymer (1) and from 0 parts by weight exclusive to 15 parts by weight inclusive of a polymer (2), provided that the total of the polymer (1) and the polymer (2) is 100 parts by weight,

the polymer (1) being a saponified ethylene-vinyl acetate copolymer having an ethylene unit content of from 20 to 60% by mole and a saponification degree of from 90 to 100%, and

the polymer (2) being a saponified ethylene-vinyl acetate copolymer having an ethylene unit content of from 85 to 95% by mole and a saponification degree of from 45 to 70%.

In order to accomplish the above-mentioned object, the ethylene unit content of the polymer (1) contained in the resin composition in accordance with the present invention is from 20 to 60% by mole, preferably from 25 to 50% by mole, and more preferably from 30 to 45% by mole.

When an EVOH having an ethylene unit content of less than 20% by mole is used in place of the polymer (1), gas-barrier properties of the resulting resin composition markedly deteriorate under high humidity conditions. On the other hand, when an EVOH having an ethylene unit content exceeding 60% by mole is used, gas-barrier properties of the resulting resin composition are insufficient under dry conditions and under high humidity conditions.

The saponification degree of the polymer (1) contained in the resin composition in accordance with the present invention is 90% or more, preferably 95% or more, and more preferably 97% or more.

When an EVOH having a saponification degree of less than 90% is used in place of the polymer (1), gas-barrier properties of the resulting resin composition are insufficient under dry conditions and under high humidity conditions.

The resin composition in accordance with the present invention may contain only one kind of EVOH meeting the conditions of the polymer (1), or contain two or more EVOHs different from one another in ethylene unit content and in saponification degree, as far as these EVOHs meet the conditions of the polymer (1).

The ethylene unit content of the polymer (2) contained in the resin composition in accordance with the present invention falls within the range of from 85% by mole inclusive to 95% by mole inclusive.

When an EVOH having an ethylene unit content of less than 85% by mole is used in place of the polymer (2), gas-barrier properties of the resulting resin composition are insufficient under high humidity conditions. On the other hand, an EVOH having an ethylene unit content exceeding 95% by mole is poor in compatibility with the polymer (1), and therefore, when it is used in place of the polymer (2), gas-barrier properties of the resulting resin composition are insufficient under dry conditions and under high humidity conditions.

The saponification degree of the polymer (2) ranges from 45 to 70%.

An EVOH having a saponification degree of less than 45% is poor in compatibility with the polymer (1), and therefore, when it is used in place of the polymer (2), gas-barrier properties of the resulting resin composition are insufficient. On the other hand, when an EVOH having a saponification degree exceeding 70% is used, gas-barrier properties of the resulting resin composition are insufficient under high humidity conditions.

The resin composition in accordance with the present invention may contain only one kind of EVOH meeting the conditions of the polymer (2), or contain two or more EVOHs different from one another in their ethylene unit content and their saponification degree, as far as these EVOHs meet the conditions of the polymer (2).

The amount of the polymer (2) contained in the resin composition in accordance with the present invention ranges from 0 part by weight exclusive to 15 parts by weight inclusive, provided that the total of the polymer (1) and the polymer (2) is assigned to be 100 parts by weight. The lower limit value thereof is preferably 0.5 part by weight, more preferably 1 part by weight, and particularly preferably 2 parts by weight. The upper limit value thereof is preferably 10 parts by weight.

When the polymer (2) is used in an amount of more than 15 parts by weight, gas-barrier properties of the resulting resin composition are insufficient under dry conditions and under high humidity conditions.

The total content of the polymers (1) and (2) in the whole resin composition in accordance with the present invention is not always critical. However, it ranges usually from 50 to 100%, preferably from 70 to 100% and more preferably from 90 to 100%, based on the whole resin composition.

How to produce the polymer (1) and the polymer (2) contained in the resin composition in accordance with the present invention is not particularly limited. One example thereof includes a process comprising saponifying an ethylene-vinyl acetate copolymer copolymerized so as to have a desired ethylene unit content. The ethylene unit content of the ethylene-vinyl acetate copolymer to be saponified and the saponification conditions are appropriately controlled, so that the polymer (1) and the polymer (2) can be obtained.

The saponification process of the ethylene-vinyl acetate copolymer is not particularly limited. For example, there can be applied a process comprising the steps of dissolving an ethylene-vinyl acetate copolymer in an organic solvent, specifically, an aromatic hydrocarbon such as xylene, toluene or benzene, performing saponification using an alkali catalyst, adding a bad solvent for the ethylene-vinyl acetate copolymer such as methanol to the reaction system, thereby precipitating a product, and then separating the product; and a process comprising the steps of dispersing the ethylene-vinyl acetate copolymer in a pellet or powder form in an alcohol such as methanol, ethanol or isopropanol, performing saponification using an alkali catalyst, removing the alcohol and the catalyst by filtration, and washing the residue with an alcohol.

As the alkali catalyst, alkali metal alkoxides, particularly sodium methoxide and sodium ethoxide, and alkali metal hydroxides, particularly sodium hydroxide and potassium hydroxide, can be used.

The saponification conditions of ethylene-vinyl acetate copolymers are, for example, as follows.

Concentration of reaction substrate (ethylene-vinyl acetate copolymer): 10 to 50%

Reaction temperature: 30 to 60° C.

Reaction time: 1 to 6 hours

Amount of catalyst used: 0.02 to 0.6 equivalent (per an acetate group).

The saponification degree can be controlled by controlling the reaction conditions including the concentration of reaction substrate, the reaction temperature, the reaction time and the amount of catalyst used.

The polymer (1) and/or the polymer (2) to be contained in the resin composition in accordance with the present invention may be modified with a copolymerizable monomer such as α-olefins, unsaturated acids, unsaturated acid anhydrides, unsaturated acid salts, olefinsulfonic acids, olefinsulfonates, mono or dialkyl esters, nitrites, amides, alkyl vinyl ethers or vinyls in a manner such that the characteristic features of the resin composition in accordance with the present invention are not remarkably marred.

Further, the resin composition in accordance with the present invention may contain additives and resins other than the polymer (1) and the polymer (2) in a manner such that the characteristic features of the resin composition in accordance with the present invention are not remarkably marred.

The resins other than the polymers (1) and (2), which the resin composition in accordance with the present invention may contain, includes, for example, the following thermoplastic resins. The resin composition in accordance with the present invention may contain one kind of such a resin or two or more kinds of such resins in addition to the polymer (1) and the polymer (2).

Polyolefin resins

Ethylene-vinyl ester copolymers

Ethylene-(meth)acrylic acid copolymers

Ethylene-(meth)acrylic acid ester copolymers

Polyester resins

Polyamide resins

Acrylic resins

Acrylonitrile resins

Polyvinyl alcohols

Polycarboxylic acids (anhydrides)

Saponified ethylene-vinyl acetate copolymers

other than the polymers (1) and (2)

Specific examples of the additives, which the resin composition in accordance with the present invention may contain, are antioxidants, photo-stabilizers, ultraviolet absorbers, anti-fogging agents, anti-misting agents, plasticizers, antistatic agents, lubricants and coloring agents.

A process for producing the resin composition in accordance with the present invention, in other words, a method of blending the polymer (1), the polymer (2) and optional components added (resins and additives), is not particularly limited and can be exemplified by a process comprising melt-kneading the materials using a single or twin screw extruder usually used for kneading resins. How to feed the polymer (1), the polymer (2) and other optional components is not particularly limited and can be exemplified by a process comprising dry-blending the materials in a pellet or powder form in advance and then feeding the resulting blend into an extruder using an apparatus such as a feeder or a compactor; and a process comprising separately feeding respective materials using feeders. Further, it is permitted to dissolve one or more materials in a solvent (mainly an organic solvent) and then pumping the resulting solution into an extruder.

Alternatively, the polymer (1) and/or the polymer (2) and any desired additional component may be blended and kneaded in each appropriate amount with a high concentration master batch of the polymer (1) and/or the polymer (2) prepared in advance, thereby obtaining the resin composition in accordance with the present invention.

The resin composition in accordance with the present invention exhibits an oxygen transmittance of approximately 12 cc/m².day.atom or less per 1 μm thickness, when measured under conditions of 23° C. and a relative humidity of 0%. While, the resin composition in accordance with the present invention exhibits an oxygen transmittance of approximately 55 cc/m².day.atom or less per 1 μm thickness, when measured under conditions of 23° C. and a relative humidity of 90%. Thus, the resin composition in accordance with the present invention exhibits superior gas-barrier properties under high humidity conditions such as 80% RH or higher as well as under low humidity conditions. As a result, in the case where goods easily degraded due to the presence of oxygen are hermetically wrapped with a wrapping material obtained using a formed product provided with a layer comprising the resin composition in accordance with the present invention, it is possible to effectively prevent oxygen from passing into the package through the wrapping material, even when humidity outside the package becomes high, or the goods wrapped is of high water activity. Many foods heat-cooked using a microwave oven contain a large quantity of moisture. Such foods include boiled rice, daily dishes such as boiled and seasoned food, and curry. When a formed product provided with a layer comprising the resin composition in accordance with the present invention is used for wrapping such foods as a wrapping material for microwave oven heating use, a superior oxygen gas-barrier property can be attained in spite of a large quantity of moisture existing in the package, and as a result, the content can be effectively prevented from deterioration.

In the present invention, the oxygen transmittance is measured by the following method according to JIS K-7126.

First, the resin composition is subjected to hot-press at 210° C. for 3 minutes, and further subjected to cool-press at 30° C. for 5 minutes, thereby obtaining a specimen film having a thickness of 30 μm. Successively, the specimen film is mounted to a measurement apparatus, and an oxygen transmittance is continuously measured. The oxygen transmittance is determined at the time when the oxygen transmittance is found to be substantially constant (usually several hours to about three days after beginning of the measurement). For measuring the oxygen transmittance, an oxygen transmittance measurement apparatus manufactured by MOCON U. S. A. (commercial name: OX-TRAN 100) or an apparatus equivalent thereto is used.

From the oxygen transmittance actually measured by the above-described method, an oxygen transmittance per 1 μm thickness is calculated. Using the calculated value, the oxygen transmittance of the resin composition is expressed. The oxygen transmittance (cc/m².day.atom) of a film comprising the same resin composition is inversely proportional to a thickness of the film.

The resin composition in accordance with the present invention can be processed into a formed product, such as a film, a sheet, a pipe, a cup or a bottle, that is provided with a layer comprising said resin composition. Such a formed product may be a product provided with a single layer comprising the resin composition in accordance with the present invention, or a laminate product provided with a layer comprising the resin composition in accordance with the present invention and one or more layers comprising a different material. In the formed product provided with the layer comprising the resin composition in accordance with the present invention, the thickness of the layer comprising the resin composition in accordance with the present invention varies depending upon a degree of gas-barrier properties required for the formed product; however, the thickness is usually within the range of from 10 to 500 μm, and more preferably within the range of from 15 to 100 μm. The formed product obtained using the resin composition in accordance with the present invention is suitably used for food wrapping materials, medicine wrapping materials, electronic part wrapping materials and gasoline tanks, and particularly suitably used for food wrapping materials.

In a multi-layered formed product provided with a layer comprising the resin composition in accordance with the present invention, the layer other than that of the present resin composition is not particularly limited, as far as a characteristic features of the layer comprising the resin composition in accordance with the present invention are not marred, and it may be, for example, a layer of woven fabric, non-woven fabric, knitted fabric, a sheet, a film or a mesh article. The material of the layer other than that comprising the resin composition in accordance with the present invention can be appropriately selected depending upon applications of the formed product etc. Specific examples of the material include thermoplastic resins, thermosetting resins, rubbers, thermoplastic elastomers, natural fibers such as hemp, and minerals such as calcium silicate. Further, it is permitted to use wood, paper, synthetic paper made of polypropylene or polystyrene, foams, and thin plates and foils of metals such as aluminum or iron.

The layer other than that comprising the resin composition in accordance with the present invention can be provided to the formed product for the purpose of improving mechanical properties such as flexural rigidity, compressive strength, surface-scratch property and dimensional stability, improving functionality such as heat resistance, heat insulation, moldability and water vapor-barrier property, or imparting characteristics such as gloss, surface smoothness and beautiful appearance.

The layer other than that comprising the resin composition in accordance with the present invention may have a single layer structure or a multi-layer structure comprising two or more layers.

Specific examples of the thermoplastic resins constituting the layer other than that comprising the resin composition in accordance with the present invention include polyolefin resins such as low density polyethylenes, high density polyethylenes, ethylene-propylene copolymers, ethylene-butene copolymers, ethylene-hexene copolymers, ethylene-octene copolymers and polypropylenes; hydrogen bond resins such as ethylene-vinyl ester copolymers, ethylene-(meth)acrylic acid ester copolymers, polyester resins, polyamide resins, acrylic resins, acrylonitrile resins, hydrophobic cellulose resins, halogen-containing resins, polyvinyl alcohols and cellulose derivatives; and engineering plastic resins such as ionomer resins, polycarbonate resins, polysulfone resins, polyether sulfone resins, polyether ether ketone resins, polyphenylene ether resins, polyphenylene oxide resins, polyarylene sulfide resins, polymethylene oxide resins, polyacetal resins, liquid crystal polyester resins and aramide resins. Further, it is also permitted to use the so-called modified resins obtained by subjecting those resins to graft-modification, cross-linking or modification of molecular chain terminals.

In using the formed product provided with the layer comprising the resin composition in accordance with the present invention for food wrapping, it is preferred that the formed product has a non-oriented polypropylene film (CPP), an oriented polypropylene film (OPP) or a thermoplastic resin foamed layer as an additional layer. Particularly in using the formed product provided with the layer comprising the resin composition in accordance with the present invention as a package for microwave oven heating use, it is preferred that the formed product is a laminate having an inorganic filler such as talc or polystyrene-containing polypropylene resin layer or a polypropylene foamed layer.

It is also permitted that the formed product provided with a layer comprising the resin composition in accordance with the present invention has an adhesive agent layer or an adhesive resin layer for bonding layers with one another.

Specific examples of the adhesive resin are (1) copolymers of an olefin monomer and at least one monomer selected from the group consisting of unsaturated carboxylic acids, the anhydrides thereof, epoxy group-containing vinyl monomers, unsaturated carboxylic acid esters and vinyl esters, and (2) acid-modified olefin polymers obtained through grafting using unsaturated carboxylic acids or their anhydrides.

Specific examples of the former include ethylene-(meth)acrylic acid copolymers, ethylene-(meth)acrylic acid copolymer metal cross-linked products, ethylene-glycidyl methacrylate copolymers, ethylene-glycidyl methacrylate-vinyl acetate copolymers, ethylene-glycidyl methacrylate-methyl (meth)acrylate copolymers, ethylene-(meth)acrylic acid ester copolymers, ethylene-(meth)acrylic acid ester-maleic anhydride copolymers and ethylene-vinyl acetate copolymers.

Specific examples of the latter acid modified olefin polymers obtained through grafting using unsaturated carboxylic acids or their anhydrides include maleic anhydride graft-modified ethylene polymers and maleic anhydride graft-modified propylene polymers.

As a process for producing the formed product provided with a layer comprising the resin composition in accordance with the present invention, there can be applied a forming method generally practiced in forming a thermoplastic resin, such as an extrusion forming method wherein a flat die such as T die or a circular die is used, an injection molding method or a blow molding method. According to these forming methods, it is possible to obtain a single layer formed product, and according to a co-extrusion forming method or a multi-layer blow molding method, it is also possible to obtain a multi-layered formed product.

Using the formed product obtained according to these forming methods, a multi-layered formed product can also be obtained according to a melt coating method, an extrusion lamination method or a dry lamination method.

Further, having an improved drawing property as compared to the sheets and film comprising the polymer (1) alone, the films and sheets obtained according to these forming methods can be easily stretched according to various stretching methods such as tenter stretching or tubular stretching method, or easily processed further according to thermoforming methods such as a vacuum forming method, a pressure forming method or a vacuum/pressure forming method.

Furthermore, the resin composition in accordance with the present invention is low in torque loading on an apparatus when processed and little in variation of a resin pressure, so that it is superior in processability.

For example, when the resin used in Comparative Example 1 described below was kneaded under conditions of screw temperature: 220° C., dies temperature: 220° C. and output: 20 kg/hour using a uniaxial screw extruder (screw diameter=40 mm), an electric current loading on the extruder (torque) was found to be 26 A. On the other hand, when the resin composition obtained in Example 2 described below was kneaded under the same conditions, an electric current loading on the extruder (torque) was found to be 20 A. This torque was lower than the torque when the resin used in Comparative Example 1 was kneaded. This demonstrates that the resin composition of Example 2 is superior in processability to the resin composition of Comparative Example 1.

### EXAMPLES

Examples of the present invention are given as follows, but the present invention is not limited to these examples.

Measuring methods and evaluation methods in Examples are as follows.

[Saponified ethylene-vinyl acetate copolymer]

As the saponified ethylene-vinyl acetate copolymer, commercially available products and products obtained by saponifying commercially available ethylene-vinyl acetate copolymers (EVAs) according to the following method were used.

The polymer (2) used in Example 1 was prepared as follows. A stirrer, a thermometer and a cooling tube were provided to a flask; 700 parts by weight of 1-butanol, 20 parts by weight of a film-like ethylene-vinyl acetate copolymer (ethylene unit content 89% by mole, commercial name: Sumitate KA-31, manufactured by Sumitomo Chemical Co., Ltd.) and 7 parts by weight of a methanol solution of sodium methoxide were introduced therein; and allowed to react at 50° C. for 30 minutes. Thereafter, the mixture was cooled to 40° C. or lower and then filtered to take out a film-like product. The product was washed twice with each 2000 parts by weight of water, thereby obtaining a saponified ethylene-vinyl acetate copolymer having a saponification degree of 51% (which product is expressed by B in Table 1).

Further, the above-described procedure was repeated except that reaction conditions including the concentration of reaction substrate (EVA), reaction temperature, reaction time, type of the catalyst and amount thereof used were appropriately changed, to obtain respective saponified ethylene-vinyl acetate copolymers having saponification degrees different from one another (which products are expressed by D, F, G and H, respectively, in Table 1). Saponified ethylene-vinyl acetate copolymers expressed by C and E in Table 1 are commercially available ones.

[Saponification Degree]

The saponification degree of the polymer (2), a saponified ethylene-vinyl acetate copolymer, was determined as follows. FT-IR spectra of the saponified ethylene-vinyl acetate copolymer and the starting ethylene-vinyl acetate copolymer before the saponification, which were in a film form, were measured. Using the absorption peak assigned to C-H deformation vibration (near 1466 cm⁻¹) of the methylene group as an internal standard, the decrease in absorbance of the peak assigned to a C═O stretching vibration (near 1738 cm⁻¹) of the vinyl acetate unit was measured to determine the saponification degree. Specifically, it was determined using the following equation.

Saponification degree (%)={1−(A₂×B₁)/(A₁×B₂)}×100

A₁: absorbance assigned to C═O stretching vibration (near 1738 cm⁻¹) of the carbonyl group of the ethylene-vinyl acetate copolymer before saponification

A₂: absorbance assigned to C═O stretching vibration (near 1738 cm⁻¹) of the carbonyl group of the ethylene-vinyl acetate copolymer

B₁: absorbance assigned to C—H deformation vibration (near 1466 cm⁻¹) of the methylene group of the ethylene-vinyl acetate copolymer before saponification (internal standard)

B₂: absorbance assigned to C—H deformation vibration (near 1466 cm⁻¹) of the methylene group of the ethylene-vinyl acetate copolymer (internal standard)

[Oxygen Transmittance]

The oxygen transmittance was measured according to JIS K-7126 (isobaric pressure method).

A specimen film was mounted to a commercially available oxygen transmittance measurement apparatus (commercial name: OX-TRAN 100, manufactured by MOCON U. S. A.), and the oxygen transmittance was continuously measured and determined at the time when the oxygen transmittance was found to be substantially constant.

As the specimen film, a film having a thickness of 30 μm obtained by subjecting the resin composition to hot-press at 210° C. for 3 minutes, followed by cool-press at 30° C. for 5 minutes, was used. From the oxygen transmittance actually measured by the above measurement, an oxygen transmittance per 1 μm thickness was calculated, and using the calculated value, the oxygen transmittance of the resin composition was expressed.

### Example 1

90 Parts by weight of a saponified ethylene-vinyl acetate copolymer (polymer (1)) having an ethylene unit content of 32% by mole and a saponification degree of 99% was mixed with 10 parts by weight of a saponified ethylene-vinyl acetate copolymer (polymer (2)) having an ethylene unit content of 89% by mole and a saponification degree of 51%. The resulting mixture was kneaded under conditions of a rotor rotating speed: 80 rpm and a temperature: 220° C. for 5 minutes using a Laboplastomil [30C150, manufactured by Toyo Seiki Seisaku-sho, LTD.]. The performances of the obtained resin composition were evaluated. The results are shown in Table 1.

### Example 2

Example 1 was repeated except that a saponified ethylene-vinyl acetate copolymer having an ethylene unit content of 89% by mole and a saponification degree of 60% was used in place of the polymer (2) used in Example 1, to obtain a resin composition. The performances the resin composition were evaluated. The results are shown in Table 1.

### Example 3

Example 2 was repeated except that 95 parts by weight of the polymer (1) used in Example 2 and 5 parts by weight of the polymer (2) used in Example 2 were mixed, to obtain a resin composition. The performances of the resin composition were evaluated. The results are shown in Table 1.

### Example 4

Example 2 was repeated except that 98 parts by weight of the polymer (1) used in Example 2 and 2 parts by weight of the polymer (2) used in Example 2 were mixed, to obtain a resin composition. The performances of the resin composition were evaluated. The results are shown in Table 1.

### Example 5

Example 1 was repeated except that a saponified ethylene-vinyl acetate copolymer having an ethylene unit content of 89% by mole and a saponification degree of 65% was used in place of the polymer (2) used in Example 1, to obtain a resin composition. The performances of the resin composition were evaluated. The results are shown in Table 1.

### Example 6

Example 5 was repeated except that 98 parts by weight of the polymer (1) used in Example 5 and 2 parts by weight of the polymer (2) used in Example 5 were mixed, to obtain a resin composition. The performances of the resin composition were evaluated. The results are shown in Table 1.

### Comparative Example 1

The performances of a saponified ethylene-vinyl acetate copolymer having an ethylene unit content of 32% by mole and a saponification degree of 99% were evaluated. The results are shown in Table 1.

### Comparative Example 2

Example 1 was repeated except that a saponified ethylene-vinyl acetate copolymer having an ethylene unit content of 82% by mole and a saponification degree of 55% was used in place of the polymer (2) used in Example 1, to obtain a resin composition. The performances of the resin composition were evaluated. The results are shown in Table 1.

### Comparative Example 3

Example 2 was repeated except that 80 parts by weight of the polymer (1) used in Example 2 and 20 parts by weight of the polymer (2) used in Example 2 were mixed, to obtain a resin composition. The performances of the resin composition were evaluated. The results are shown in Table 1.

### Comparative Example 4

Example 1 was repeated except that a saponified ethylene-vinyl acetate copolymer having an ethylene unit content of 89% by mole and a saponification degree of 38% was used in place of the polymer (2) used in Example 1, to obtain a resin composition. The performances of the resin composition were evaluated. The results are shown in Table 1.

### Comparative Example 5

Example 1 was repeated except that a saponified ethylene-vinyl acetate copolymer having an ethylene unit content of 89% by mole and a saponification degree of 76% was used in place of the polymer (2) used in Example 1, to obtain a resin composition. The performances of the resin composition were evaluated. The results are shown in Table 1.

### Comparative Example 6

Example 1 was repeated except that a saponified ethylene-vinyl acetate copolymer having an ethylene unit content of 89% by mole and a saponification degree of 95% was used in place of the polymer (2) used in Example 1, to obtain a resin composition. The performances of the resin composition were evaluated. The results are shown in Table 1.

### Comparative Example 7

Comparative Example 6 was repeated except that 98 parts by weight of the polymer (1) used in Comparative Example 6 and 2 parts by weight of the polymer (2) used in Comparative Example 6 were mixed, to obtain a resin composition. The performances of the resin composition were evaluated. The results are shown in Table 1.

TABLE 1

| | | Example | | | | | | Comparative Example | | | | | | |
|---|---|---|---|---|---|---|---|---|---|---|---|---|---|---|
| | | 1 | 2 | 3 | 4 | 5 | 6 | 1 | 2 | 3 | 4 | 5 | 6 | 7 |
| First | Kind | A | A | A | A | A | A | A | A | A | A | A | A | A |
| component | Blending | 90 | 90 | 95 | 98 | 90 | 98 | 100 | 90 | 80 | 90 | 90 | 90 | 98 |
| | proportion | | | | | | | | | | | | | |
| | (part by weight) | | | | | | | | | | | | | |
| Second | Kind | B | C | C | C | D | D | — | E | C | F | G | H | H |
| component | Ethylene | 89 | 89 | 89 | 89 | 89 | 89 | — | 82 | 89 | 89 | 89 | 89 | 89 |
| | unit content | | | | | | | | | | | | | |
| | (mol %) | | | | | | | | | | | | | |
| | Saponification | 51 | 60 | 60 | 60 | 65 | 65 | — | 55 | 60 | 38 | 76 | 95 | 95 |
| | degree (%) | | | | | | | | | | | | | |
| | Blending | 10 | 10 | 5 | 2 | 10 | 2 | — | 10 | 20 | 10 | 10 | 10 | 2 |
| | proportion | | | | | | | | | | | | | |
| | (part by weight) | | | | | | | | | | | | | |
| Oxygen | 0% RH | 12 | 9 | 5 | 2 | 9 | 3 | 14 | 18 | 20 | 16 | 22 | 9 | 15 |
| trans- | | | | | | | | | | | | | | |
| mittance | | | | | | | | | | | | | | |
| (cc/m² · | 90% RH | 50 | 42 | 54 | 42 | 36 | 55 | 62 | 68 | 69 | 90 | 124 | 111 | 74 |
| day · atm) | | | | | | | | | | | | | | |

The meanings of the marks in Table are as follows.
A: saponified ethylene-vinyl acetate copolymer having an ethylene unit content of 32% by mole and a saponification degree of 99%
B: saponified ethylene-vinyl acetate copolymer having an ethylene unit content of 89% by mole and a saponification degree of 51%
C: saponified ethylene-vinyl acetate copolymer having an ethylene unit content of 89% by mole and a saponification degree of 60%
D: saponified ethylene-vinyl acetate copolymer having an ethylene unit content of 89% by mole and a saponification degree of 65%
E: saponified ethylene-vinyl acetate copolymer having an ethylene unit content of 82% by mole and a saponification degree of 55%
F: saponified ethylene-vinyl acetate copolymer having an ethylene unit content of 89% by mole and a saponification degree of 38%
G: saponified ethylene-vinyl acetate copolymer having an ethylene unit content of 89% by mole and a saponification degree of 76%
H: saponified ethylene-vinyl acetate copolymer having an ethylene unit content of 89% by mole and a saponification degree of 95%

### ADVANTAGES OF THE INVENTION

The resin composition in accordance with the present invention contains from 85 parts by weight inclusive to 100 parts by weight exclusive of a saponified ethylene-vinyl acetate copolymer having an ethylene unit content of from 20 to 60% by mole and a saponification degree of from 90 to 100% [polymer (1)], and from 0 parts by weight exclusive to 15 parts by weight inclusive of a saponified ethylene-vinyl acetate copolymer having an ethylene unit content of from 85 to 95% by mole and a saponification degree of from 45 to 700% [polymer (2)], and as a result exhibits superior gas-barrier properties under high humidity conditions such as the relative humidity of not less than 80% RH as well as under dry conditions, as compared to the above polymer (1) alone. Accordingly, use of the resin composition in accordance with the present invention provides wrapping materials exhibiting superior gas-barrier properties under high humidity conditions as well as under dry conditions, which is suitably used for wrapping high moisture foods or the like.

1. A resin composition comprising from 85 parts by weight inclusive to 100 parts by weight exclusive of a polymer (1) and from 0 parts by weight exclusive to 15 parts by weight inclusive of a polymer (2), provided that the total of the polymer (1) and the polymer (2) is 100 parts by weight,
the polymer (1) being a saponified ethylene-vinyl acetate copolymer having an ethylene unit content of from 20 to 60% by mole and a saponification degree of from 90 to 100%, and
the polymer (2) being a saponified ethylene-vinyl acetate copolymer having an ethylene unit content of from 85 to 95% by mole and a saponification degree of from 45 to 70%.

2. A formed molded product characterized by having a layer comprising the resin composition according to claim 1.
